(19) United States
(12) Patent Application Publication
(10) Pub. No.: US 2023/0106867 A1
(43) Pub. Date: Apr. 6, 2023

(54) CLOUD-BASED MANAGEMENT OF USER ACCOUNTS, USER PROFILES AND USER DEVICES ASSOCIATED WITH A VEHICLE

(71) Applicant: RIVIAN IP HOLDINGS, LLC, Irvine, CA (US)

(72) Inventors: Vincent Wai-Yuen Chan, Dublin, CA (US); David A. Fung, Cupertino, CA (US); Philipp Beisel, San Jose, CA (US); Leonid Kokhnovych, Burnaby (CA); Vivek Ravi, San Jose, CA (US); Paul Chui, Fremont, CA (US)

(21) Appl. No.: 17/857,819

(22) Filed: Jul. 5, 2022

Related U.S. Application Data
(60) Provisional application No. 63/248,265, filed on Sep. 24, 2021.

(51) Int. Cl. G06F 21/35; B60R 25/31; B60R 25/24; H04L 67/306

(52) U.S. Cl. CPC G06F 21/35; B60R 25/31; B60R 25/241; H04L 67/306; B60R 25/01

(57) ABSTRACT

Systems and methods are provided for associating, by a server and in a data store maintained by the server, a user account with a vehicle; associating, by the server and in the data store, the user account with a user profile, the user profile including one or more preferred vehicle attribute settings; upon receiving an indication that a user is approaching the vehicle, causing, by the server, the user account to be automatically logged into at the vehicle; in response to logging into the user account, retrieving, by the server, the user profile associated with the user account; and causing, by the server, the user profile to be loaded at the vehicle such that attributes of the vehicle are modified based on the preferred vehicle attribute settings stored in the user profile.

### CROSS-REFERENCE TO RELATED APPLICATION

This application claims the benefit of U.S. Provisional Application No. 63/248,265 filed Sep. 24, 2021, the disclosure of which is hereby incorporated by reference herein in its entirety

### INTRODUCTION

Some vehicles permit a user to access an in-vehicle user account specifying certain preferences of the user. However, such user profiles are generally linked to a physical key fob of the user, which does not provide the user with much flexibility. For example, such arrangement limits the capability of the user to utilize his or her user profile in a different vehicle, grant or revoke access to the vehicle for other users, and manage a plurality of profiles and associated vehicles efficiently.

### SUMMARY

Accordingly, systems, apparatuses (e.g., vehicles), and methods are disclosed herein comprising associating, by a server and at a data store, a user account with a vehicle and with a user profile, where the user profile includes one or more preferred vehicle attribute settings. Upon receiving an indication that a user is approaching the vehicle, the server may cause the user account to be automatically logged into at the vehicle. In response to logging into the user account, the server retrieves the user profile associated with the user account, and the server cause the user profile to be loaded at the vehicle such that attributes of the vehicle are modified based on the preferred vehicle attribute settings stored in the user profile. Such aspects may enable a user to create a cloud-based identity which is associated with his or her assets, which may include one or more vehicles, and the system may maintain synchronization of user account state between the cloud (e.g., comprising any suitable number of servers, databases and/or other computing resources), vehicles, user devices and applications.

In some embodiments, the server associates the user account with a user device. In some embodiments, the user device is a smartphone, key fob, or short-range wireless access device (e.g., key card or key wristband).

In some embodiments, receiving an indication that the user device is approaching the vehicle comprises receiving an indication of user interaction with the user device within a predefined vicinity of the vehicle.

In some embodiments, the provided systems and methods further comprise associating, by the server and at the data store, the user account with a secondary vehicle; causing, by the server, the user account to be automatically logged into the secondary vehicle; in response to logging into the user account at the secondary vehicle, retrieving, by the server, the user profile associated with the user account; and causing the user profile to be loaded at the secondary vehicle such that attributes of the secondary vehicle are modified based on the preferred vehicle attribute settings stored in the user profile

In some embodiments, the user account is associated with a user, and the provided systems and methods further comprise associating, by the server and at the data store, the user account with a plurality of user profiles, each of the user profiles being associated with the user; determining a current time of day or a current day of the week; and selecting the user profile from the plurality of user profiles based on the determined current time of day or current day of the week.

In some embodiments, the user account is associated with a user, and the provided systems and methods further comprise associating, by the server and at the data store, the user account with a plurality of user profiles, each of the user profiles being associated with the user; and determining that one of the plurality of user profiles is specified as a preferred user profile, wherein retrieving, by the server, the user profile associated with the user account comprises retrieving the preferred user profile such that attributes of the vehicle are modified based on the preferred vehicle attribute settings stored in the preferred user profile.

In some embodiments, causing the user profile to be loaded at the vehicle comprises: causing an identifier of the user profile to be generated for display at a display of the vehicle; and receiving selection of the identifier.

In some embodiments, the provided systems and methods further comprise associating, by the server and at the data store, a plurality of user devices with the user account, wherein logging into the vehicle is performed in response to determining that any of the plurality of user devices are approaching the vehicle.

In some embodiments, the server is configured to permit the preferred vehicle setting of the user account to be shared with another user account associated with another vehicle.

In some embodiments, the provided systems and methods further comprise associating, by the server and at the data store, a plurality of user devices with the user account; an receiving an indication from a primary user associated with the user account to provision a first user device of the plurality of user devices for a temporary user of the vehicle; associating, by the server and at the data store, the first user device with a guest account associated with the vehicle; in response to logging into the guest account, retrieving a guest profile associated with the guest account; and causing, by the server, the guest profile to be loaded at the vehicle such that attributes of the vehicle are modified based on preferred vehicle attribute settings stored in the guest profile.

In some embodiments, the provided systems and methods further comprise associating, by the server and at the data store, a plurality of user devices with the user account; receiving an indication from a primary user associated with the user account to provision a first user device of the plurality of user devices for a secondary user; associating, by the server and at the data store, the first user device with a guest account associated with the vehicle, logging into the guest account at the vehicle; and in response to logging into the guest account: retrieving a user profile of the secondary user associated with the guest account; and causing, by the server, the user profile of the secondary user to be loaded at the vehicle such that attributes of the vehicle are modified based on preferred vehicle attribute settings stored in the user profile of the secondary user.

In some embodiments, the provided systems and methods further comprise associating, by the server and at the data store, a plurality of user devices with the user account; and receiving an indication from a primary user associated with the user account to associate a first user device of the plurality of user devices with a user account associated with another user; and associating, by the server and at the data store, the first user device with the user account of said another user.

In addition, systems and methods are disclosed herein comprising associating, by a server and at a data store, an administrative account with a fleet of vehicles; associating, by the server and at the data store, a plurality of user devices with the administrative account; associating, by the server and at the data store, each of the plurality of user devices with a client account associated with a respective client user, wherein each client account comprises a respective client profile; and using the administrative account to associate respective vehicles from the fleet of vehicles to respective client accounts. In some embodiments, such fleet management techniques may employ hierarchical granting or rights to users.

In some embodiments, the provided systems and methods further comprise receiving an indication from an operator associated with the administrative account to associate global vehicle settings with the fleet of vehicles.

In some embodiments, the provided systems and methods further comprise determining that vehicle settings of a particular client profile conflict with global settings of the administrative account; and in response to determining that the conflict exists, causing the global settings to be applied instead of the conflicting client profile settings.

In some embodiments, the provided systems and methods further comprise providing a notification, to each respective client account, of which vehicle from the fleet of vehicles the client account was associated.

In some embodiments, the aforementioned features may be implemented by a system comprising memory storing instructions and control circuitry configured to execute the instructions. In some embodiments, such system comprises at least one of a vehicle, a server, and a user device.

In some embodiments, the aforementioned features may be implemented by a system comprising memory storing instructions and control circuitry configured to execute the instructions. In some embodiments, such system comprises at least one of a vehicle, a server, and a user device.

In some embodiments, the systems and methods disclosed herein may associate, by a server, a user account with a vehicle, and may associated, by the server, the user account with a user profile. The user account may be logged into at the vehicle and, in response to logging into the user account, the user profile associated with the user account may be retrieved and the user profile may be caused to be loaded at the vehicle.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a block diagram of components of a system 100 configured to load a user profile at vehicle 106, in accordance with some embodiments of the present disclosure.

FIG. 2 shows a block diagram of components of a system 200 configured to load a user profile at vehicle 206, in accordance with some embodiments of the present disclosure.

FIG. 3 shows a block diagram of a system 300 for defining identity management, in accordance with some embodiments of the present disclosure. FIG. 4 shows a block diagram of a system 400 for causing a user profile to be loaded at a vehicle, in accordance with some embodiments of the present disclosure.

FIG. 5 shows a plurality of illustrative scenarios in which system 400 may be utilized to cause a user profile to be loaded at a vehicle, in accordance with some embodiments of this disclosure.

FIG. 6 shows a block diagram illustrating various areas in which the user account may be utilized, in accordance with some embodiments of this disclosure.

FIG. 7 shows an illustrative authorization service, in accordance with some embodiments of this disclosure.

FIGS. 8A-8I shows illustrative user interface (UI) screens which may be provided, in accordance with some embodiments of this disclosure.

FIG. 9 shows a flowchart of illustrative process 900 for causing a user profile to be loaded at a vehicle, in accordance with some embodiments of the present disclosure.

FIG. 10 shows a flowchart of illustrative process 1000 for causing a user profile to be loaded at a vehicle, in accordance with some embodiments of the present disclosure.

FIG. 11 shows a flowchart of illustrative process 1000 for causing a user profile to be loaded at a vehicle, in accordance with some embodiments of the present disclosure.

### DETAILED DESCRIPTION

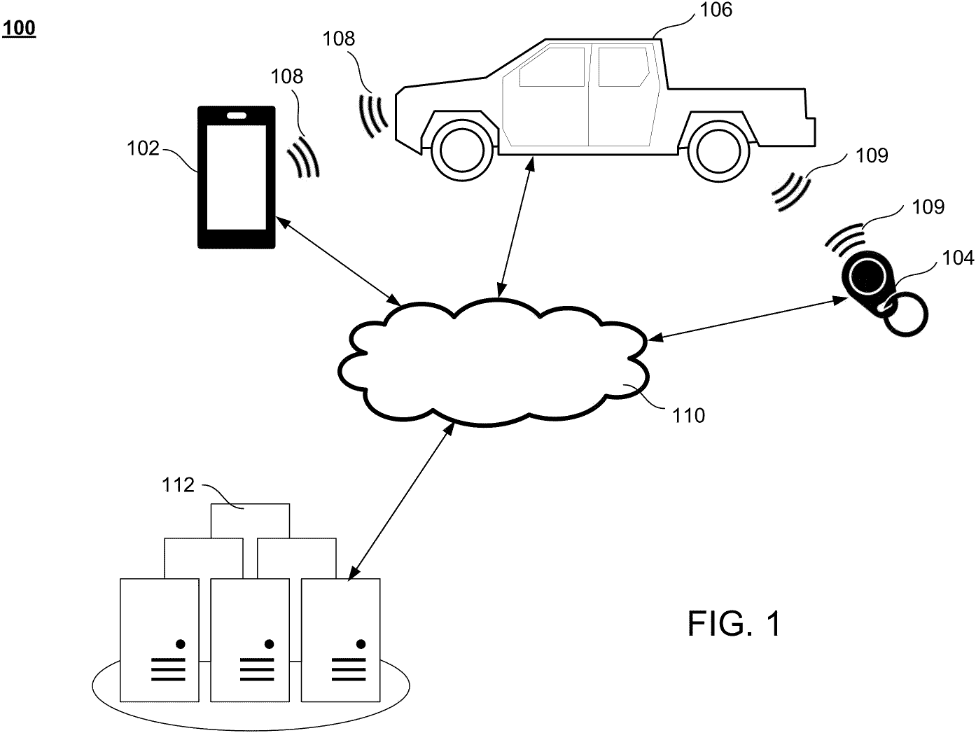

FIG. 1 shows a block diagram of components of a system 100 configured to load a user profile at vehicle 106, in accordance with some embodiments of the present disclosure. System 100 may comprise vehicle 106, one or more of user device 102 (e.g., a mobile device, such as, for example, a smart phone or a tablet) and user device 104 (e.g., a key fob, a key card, a key wristband, or any other suitable short-range wireless device, or any combination thereof) and cloud computing resources 112 (e.g., one or more remote servers, which may maintain or otherwise be in communication with one or more data stores and/or databases). Such elements of system 100 may be configured to communicate over any suitable wired and/or wireless communication path. For example, user devices 102 and 104 may be configured to communicate with vehicle 106 using a short-range radio communication technique, such as, for example, Bluetooth low energy (BLE) 108, near-field communication (NFC) 109, ultra-wideband techniques, or near-field communication (NFC) and/or any other suitable technique. In some embodiments, user devices 102 and/or 104 and vehicle 106 may communicate with server 112 over network 110, e.g., the Internet, a local area network, a wide area network, a satellite network, a cellular network, etc., and/or any other suitable technique.

In some embodiments, system 100 may utilize a cloud-based architecture to enable management of users (e.g., drivers or operators) of vehicle 106 and management of user devices 102 and 104 in association with vehicle 106. For example, server 112 may be utilized to associate one or more user accounts (e.g., each associated with a particular user ID stored at server 112 associated with a vehicle manufacturer or distributor) with vehicle 106, associate one or more user profiles with a user account, and/or associate one or more user devices with a user account. Server 112 may enable a user to log into a user account at vehicle 106, and in response to logging to the user account, retrieve (e.g., by server 112 or vehicle 106) the user profile associated with the user account, and cause the user profile to be loaded at vehicle 106. In some embodiments, server 112 may be configured to, upon receiving an indication that a user is approaching the vehicle, cause the user account to be automatically logged into at vehicle 106. In some embodiments, server 112 may be configured to communicate to vehicle 106 a list of users (e.g., user profiles and/or user accounts associated with certain users) having been granted permission to drive or otherwise interact with vehicle 106, and/or a list of user devices having been granted access to vehicle 106. In some embodiments, vehicle 106 may be configured to communicate to server 112 user preference information, user information, vehicle settings, and/or vehicle information. In some embodiments, privacy-related content (e.g., user address, phone number, etc.) and/or security-related content (e.g., 3rd party credentials) may be omitted from user profiles.

In some embodiments, a primary user account (e.g., an owner) of vehicle 106 may be provided with the ability to remotely add provisioned user accounts and/or user profiles on to their vehicle(s), to enable vehicle access to the given vehicle for the provisioned user having been added to the vehicle’s permission list. For example, such added user may be provided with the ability to set up his or her user device 102 or 104 as a key or be assigned any other enrolled wireless key device. In some embodiments, such primary user account may be provided with the ability to delete provisioned user accounts and/or profiles on their vehicle(s) associated with the primary user account. For example, the primary user account may be provided with an option to specify that vehicle access to a previously provisioned user should be immediately revoked for the given vehicle, which may cause all keys to be removed from the deleted user for one or more vehicles associated with the primary user account, or a subset of the keys to be removed for certain vehicle(s). In some embodiments, the primary user account may be provided with the ability to seamlessly re-assign keys to provisioned user accounts or user profiles. For example, a selected key (e.g., specified by the primary user account) can be designated for use for a particular provisioned user for a particular vehicle, such that the particular vehicle may associate the key with the provisioned user account or profile, and all of the functions and preferences of the user account. Such aforementioned features may provide vehicle owners with full control with respect to who has access to their vehicle at any given time.

User device 102 and/or 104 may be operable by a user to perform various functions in connection with vehicle 106 (e.g., remote start, unlocking and locking doors or hatches, pairing to a media system of vehicle 106, starting or turning of vehicle 106, signaling a panic condition, etc.) over wireless or wired communication paths. In some embodiments, user preferences may be managed locally in-vehicle and viewable remotely (e.g., via mobile and web). In some embodiments, a particular user profile and/or user account may store indications of any number of preferred vehicle attributes or user settings or preferences, e.g., profile alias, different seat positions for driver area or other passenger area, different mirror positions, HVAC climate control settings, radio preferences, exterior and interior lights preferences, locks preferences, maps (e.g., historical navigation and traffic information), media (e.g., audio, radio, video, etc.), steering wheel position, driver assistance (e.g., ADAS), units/time, welcome experience, exit experience, intuitive settings (e.g., machine learning), heads-up display preferences, layout of dashboard panel icons, air suspension, braking, drive modes (e.g., air suspension, braking preferences), adaptive cruise control, language preference, priority Bluetooth device, regenerative braking drive mode, auto hold drive mode, custom drive modes, sub-modes creep, air suspension, driving efficiency metrics, etc. In some embodiments, a particular user account may be associated with a plurality of user profiles having different preferred vehicle attribute settings. The user profiles associated with vehicle 106 may be associated with same user or any number of different users. The user account may impose global settings that apply to each user profile associated with the user account (e.g., a top speed limit), and any conflicts between settings of the user profile and the user account global settings may be resolved in favor of the global settings. In some embodiments, the owner of the vehicle or other authorized user may be permitted to override preferences of other drivers of the vehicle, e.g., an administrative override on a vehicle basis.

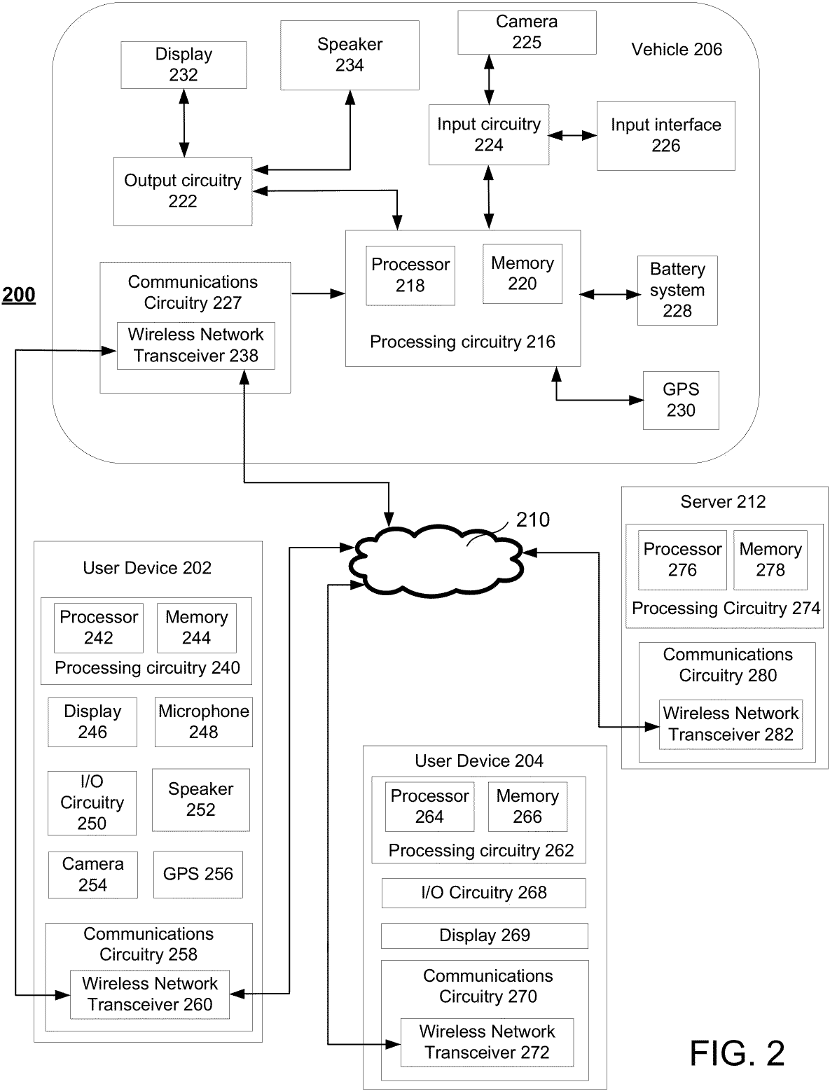

FIG. 2 shows a block diagram of components of a system 200 configured to load a user profile at vehicle 206, in accordance with some embodiments of the present disclosure. Vehicle 206 may correspond to vehicle 106 of FIG. 1, and user device 202 may correspond to user device 102 (e.g., a mobile device, such as, for example, a smartphone) or user device 204 (e.g., such as, for example, a key fob).

Vehicle 206 may be a car (e.g., a coupe, a sedan, a truck, an SUV, a bus), a motorcycle, an aircraft (e.g., a drone), a watercraft (e.g., a boat), or any other type of vehicle. Vehicle 206 may comprise processing circuitry 216 which may comprise processor 218 and memory 220. Processor 218 may comprise a hardware processor, a software processor (e.g., a processor emulated using a virtual machine), or any combination thereof. In some embodiments, processor 218 and memory 220 in combination may be referred to as processing circuitry 216 of vehicle 206. In some embodiments, processor 218 alone may be referred to as processing circuitry 216 of vehicle 206. Memory 220 may comprise hardware elements for non-transitory storage of commands or instructions, that, when executed by processor 218, cause processor 218 to operate vehicle 206 in accordance with embodiments described above and below. Processing circuitry 216 may be communicatively connected to components of vehicle 206 via one or more wires, or via wireless connection. Processing circuitry 216 may be configured to execute instructions (e.g., stored at memory 220) to implement any suitable portions of the functionalities described above and below.

Processing circuitry 216 may be communicatively connected to input interface 226 (e.g., a steering wheel, a touch screen display, buttons, knobs, a microphone or other audio capture device, etc.) via input circuitry 224. In some embodiments, a driver of vehicle 206 may be permitted to select certain settings in connection with the operation of vehicle 206 via input interface 226, and/or input interface 226 may be configured to receive selection (e.g., via haptic input or voice input) of an option to pair user device 202 or user device 204 with vehicle 206. Input interface 226 may be communicatively connected to one or more cameras 225, which may be configured to capture an internal or external environment of vehicle 206. Such images may be transmitted to processing circuitry 216 and used to, e.g., detect obstacles or vehicles in a vicinity of vehicle 206, for facial recognition purposes to authenticate a driver of vehicle 206, etc.

Processing circuitry 216 may be communicatively connected to display 232 and speaker 234 by way of output circuitry 222. Display 232 may be located at a dashboard of vehicle 206 and/or at a heads-up display at a windshield of vehicle 206. Display 232 may comprise an LCD display, an OLED display, an LED display, or any other type of display. Display 232 may be configured to display selectable identifiers associated with user profiles of a particular user account associated with vehicle 206. Speaker 234 may be located at any location within the cabin of vehicle 206, e.g., at the dashboard of vehicle 206, on an interior portion of the vehicle door, etc., and may be configured to provide audio output to a driver and/or occupant of vehicle 206.

Processing circuitry 216 may be communicatively connected to communications circuitry 227. Communications circuitry 227 may comprise wireless network transceiver 238 which may comprise any suitable hardware and/or software operable to send and receive wireless signals between vehicle 206 and external devices such as, for example, network or user devices (e.g., user device 202, user device 204, server 212, server 214 and/or a Wi-Fi access point and/or a satellite) and/or any other suitable computing devices. Wireless network transceiver 238 may include an antenna and other control circuitry (e.g., protocol converters, rate converters, signal converters), or any combination thereof. Wireless network transceiver 238 may comprise one or more components to facilitate communication over any suitable network or communication method (e.g., the Internet, short-range radio communication such as, for example, Bluetooth, BLE, NFC, etc.). For example, wireless network transceiver 238 may be configured to access the Internet, a local area network, a wide area network, a Bluetooth-enabled device, an NFC-enabled device, any other suitable device using any suitable protocol, or any combination thereof. In some embodiments, wireless network transceiver 238 may comprise a sensor configured to advertise a vehicle identifier (e.g., over a BLE link). In some embodiments, Bluetooth protocols may be used to detect that a driver or user is approaching the vehicle while NFC protocols or NFC-enabled devices (e.g., key cards, wristband) may be used to unlock the door of the vehicle (e.g., tap to unlock).

Processing circuitry 216 may be communicatively connected to battery system 228, which may be configured to provide power to one or more of the components of vehicle 206 during operation. In some embodiments, vehicle 206 may be an electric vehicle or a hybrid electric vehicle, and/or may be configured to be an autonomous or semi-autonomous vehicle. Processing circuitry 216 may be communicatively connected to GPS system 230 or other positioning device of vehicle 206, where the driver may interact with GPS system 230 via input interface 226. GPS system 230 may be in communication with (e.g., via communications circuitry 227) one or more satellites and/or servers remote from vehicle 206 to ascertain a location of vehicle 206 and provide navigation directions to processing circuitry 216. As another example, the positioning device operate may operate on terrestrial signals, such as cell phone signals, Wi-Fi signals, or ultra-wideband signals to determine a location of vehicle 206. The determined location may be in any suitable form such as a geographic coordinate, a street address, a nearby landmark such as an identification of the nearest charging station or a tagged location associated with vehicle 206 (e.g., a location of a home of the user stored in memory 220). In some embodiments, vehicle 206 may be configured to store user account information and/or user profile information.

It should be appreciated that FIG. 2 only shows some of the components of vehicle 206, and it will be understood that vehicle 206 also includes other elements commonly found in vehicles (e.g., electric vehicles), e.g., a motor, brakes, wheels, wheel controls, turn signals, windows, doors, etc.

User device 202 may be, for example, a smartphone, tablet or any suitable personal computing device operable to communicate with vehicle 206, user device 204, server 212, e.g., by way of wireless network transceiver 260. In some embodiments, user device 202 may be configured to communicate with vehicle 206 by way of a wired connection (e.g., USB connection or other data cable).

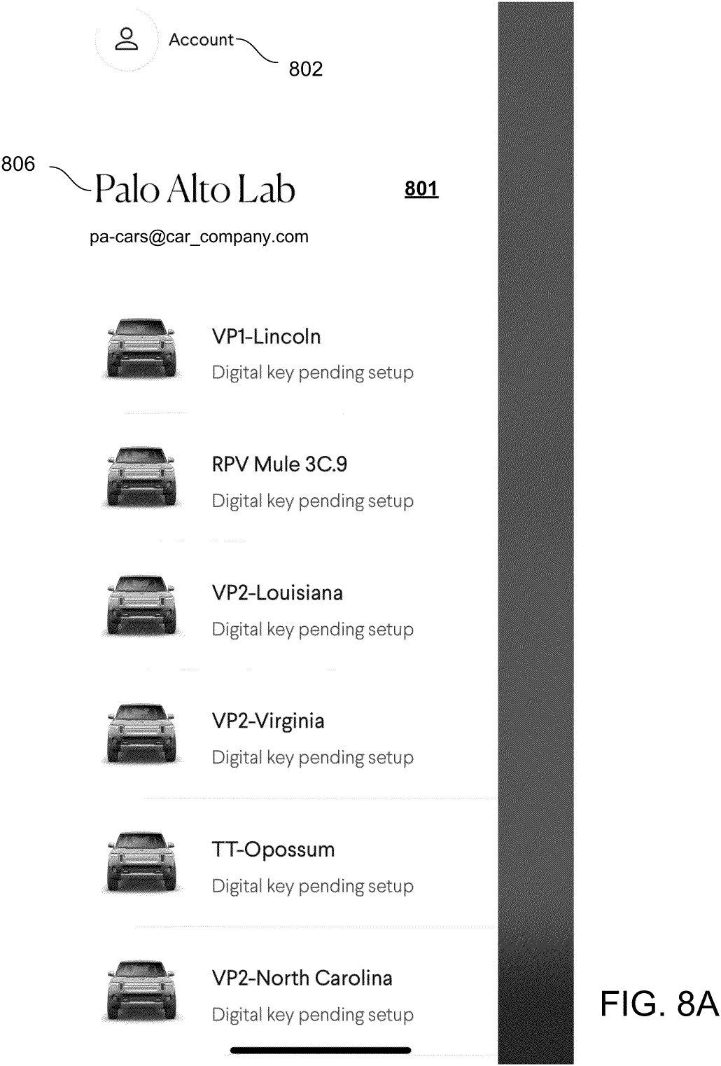

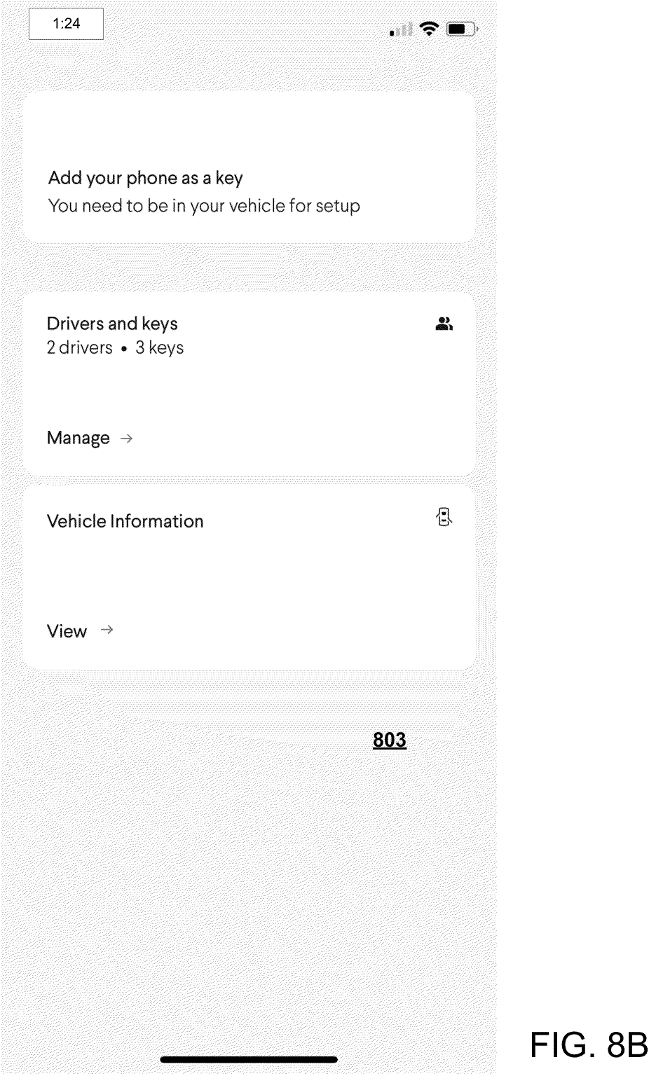

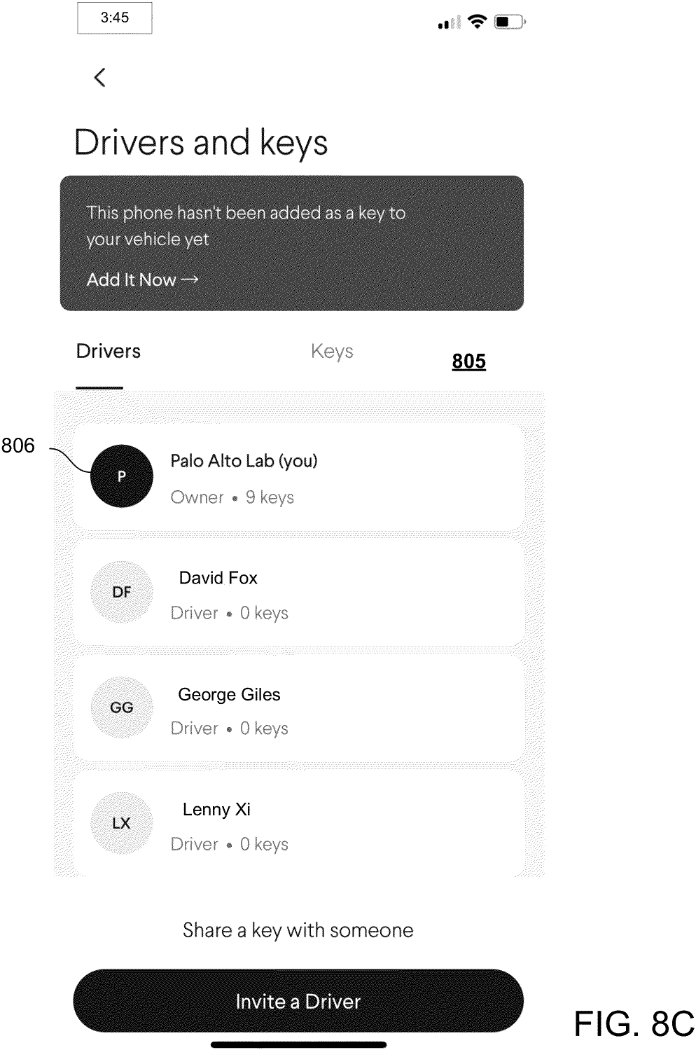

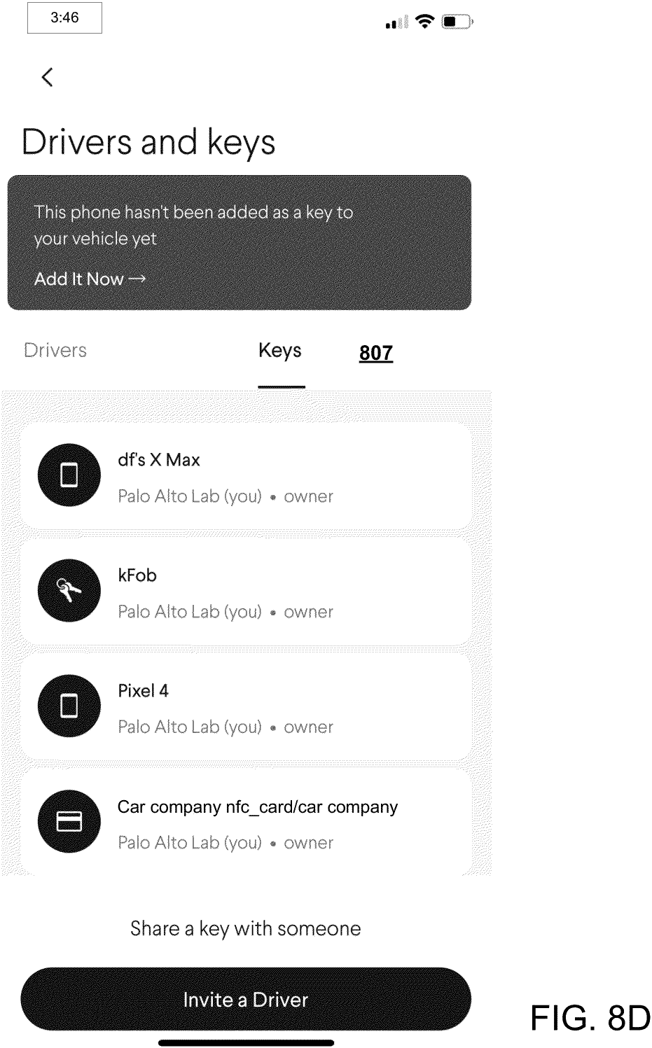

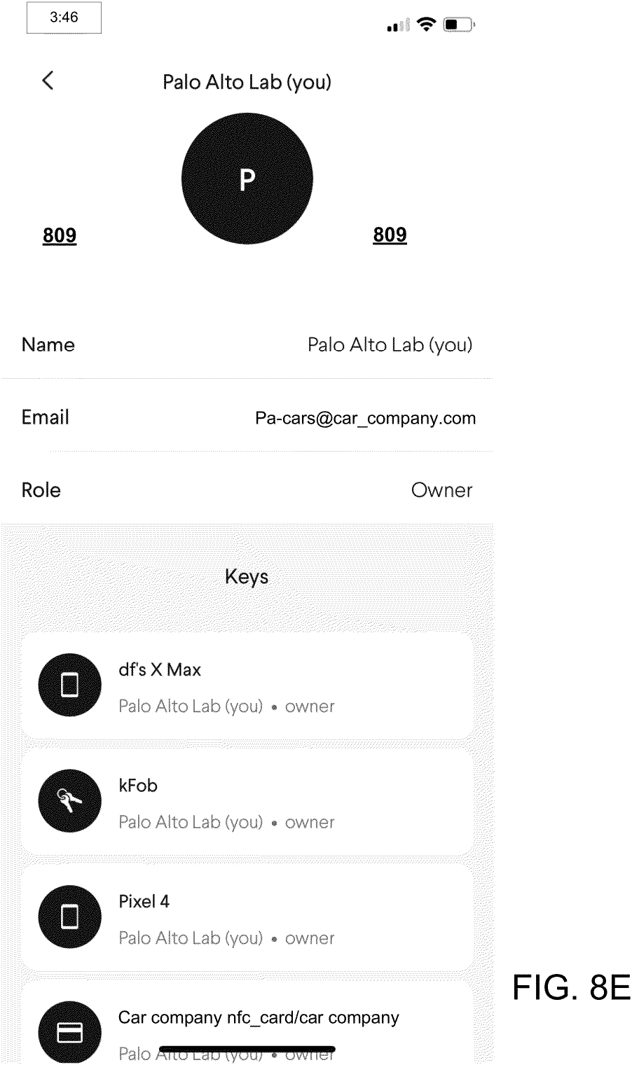

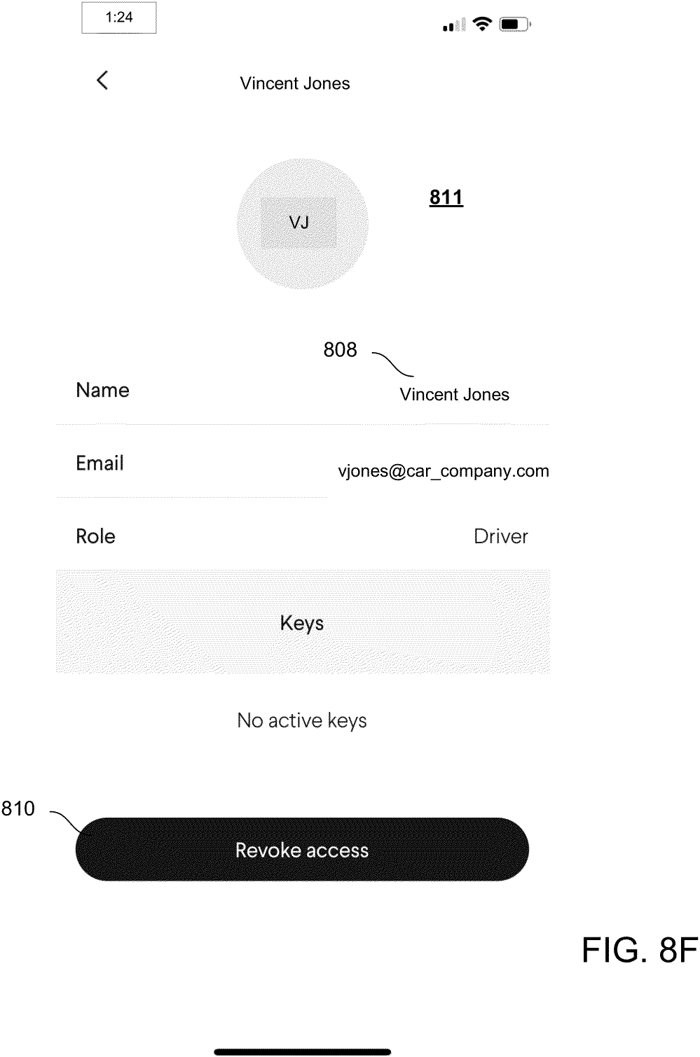

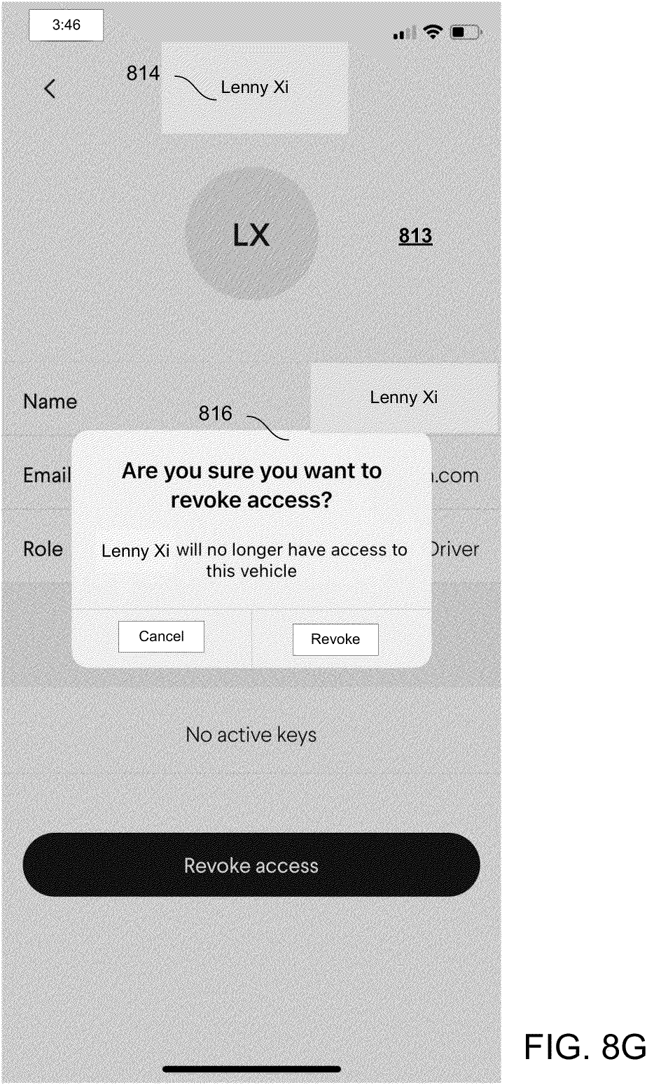

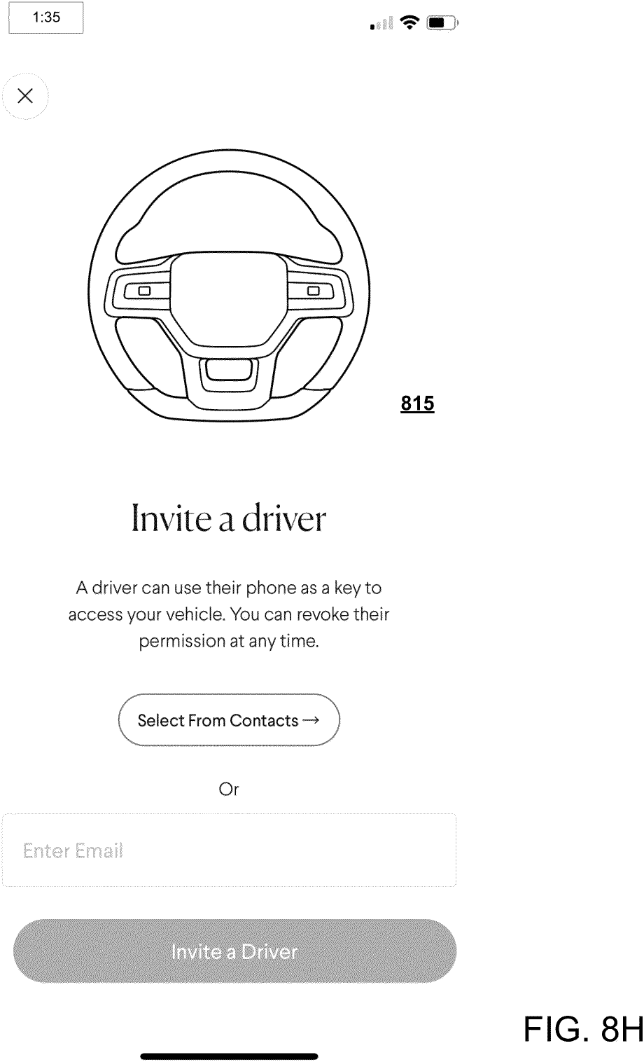

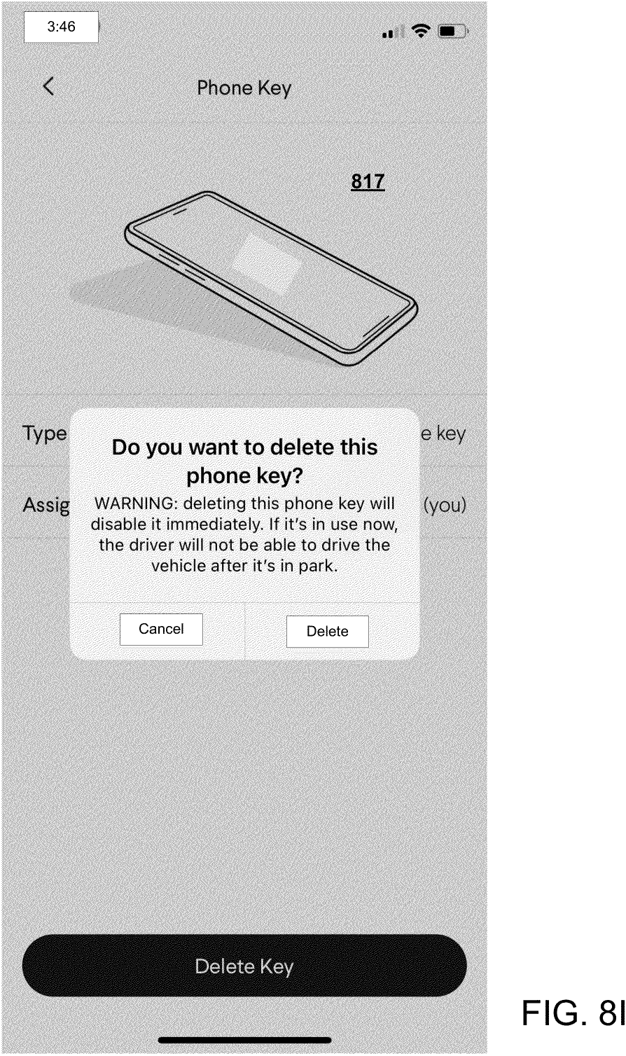

User device 202 may comprise processing circuitry 240, processor 242, memory 244, which may be implemented in a similar manner as processing circuitry 216, processor 218 and memory 220, respectively. User device 202 may further comprise display 246, microphone 248, input/output (I/O) circuitry 250, speaker 252, camera 254 and GPS 256, which may be implemented similarly to display 232, input interface 226, speaker 234, output circuitry 222 and input circuitry 224, speaker 234, camera 225 and GPS system 230. Communications circuitry 258 may be implemented in a similar manner as communications circuitry 227 of vehicle 206. Communications circuitry 258 may comprise wireless network transceiver 260 which may comprise one or more components configured to receive and transmit signals using various communication techniques. For example, wireless network transceiver 260 may enable user device 202 to communicate with vehicle 206 over a first communication path (e.g., BLE, NFC or other short-range communication technique) and wireless network transceiver 260 may enable user device 202 to communicate with server 212 over a second communication path (e.g., network 210, such as, for example, the Internet, a satellite network, etc.). In some embodiments, user device 202 may be configured to store user account information and/or user profile information, and/or execute a mobile application configured to provide various functionalities (e.g., UI screens 8A-8I of FIG. 8) and/or implement any suitable functionality described above and below.

User device 204 may be, e.g., a key fob or other short-range wireless device. User device 204 may comprise processing circuitry 262, processor 264, memory 266, I/O circuitry 268, communications circuitry 270 and wireless network transceiver 272. A key fob, an example of user device 204, may comprise one or more buttons or other features for receiving haptic input from a user. For example, in some embodiments, a key fob, an example of user device 204, comprises a number of buttons (e.g., two, three, four, or more than four buttons) that respectively correspond to a function or command. A key fob, an example of user device 204, may include a battery to provide electrical power, an antenna for transmitting and receiving signals, and processing circuitry 262 may convert user selections (e.g., presses of a button) to an electrical signal which may then be converted to a wireless signal (e.g., via the antenna). Wireless network transceiver 272 may be configured to enable user device 204 to communicate with vehicle 206 over a first communication path (e.g., BLE, NFC or other short-range communication technique) and wireless network transceiver 272 may enable user device 202 to communicate with server 212 over a second communication path (e.g., network 210, such as, for example, the Internet, a satellite network, etc.). In some embodiments, user device 204 may be configured to store user account information and/or user profile information, and/or execute a mobile application configured to provide various functionalities (e.g., UI screens 8A-8I of FIG. 8).

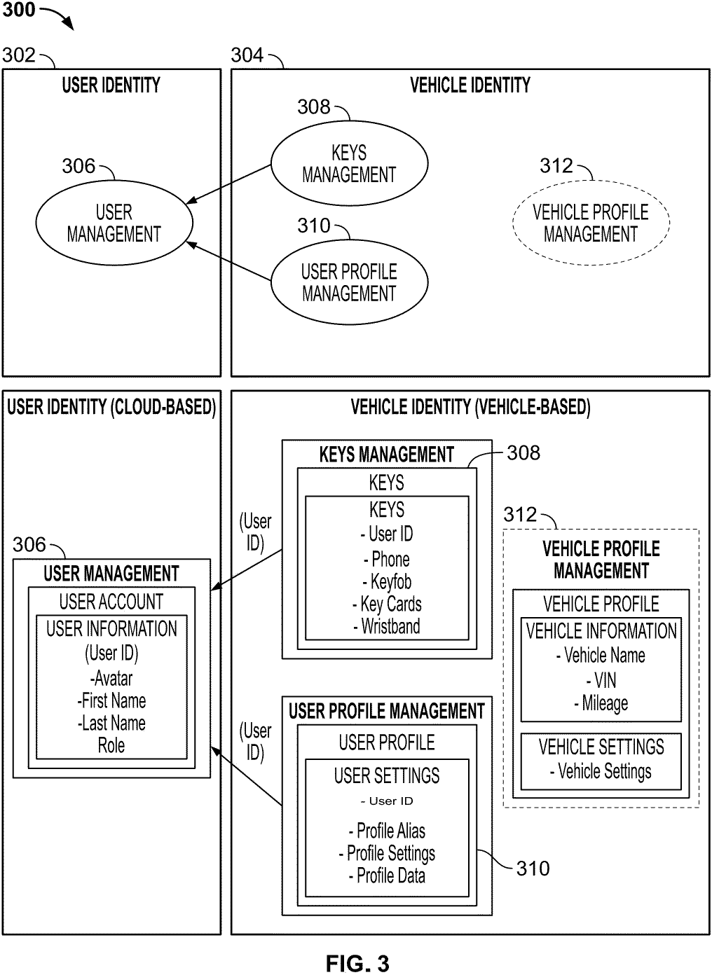

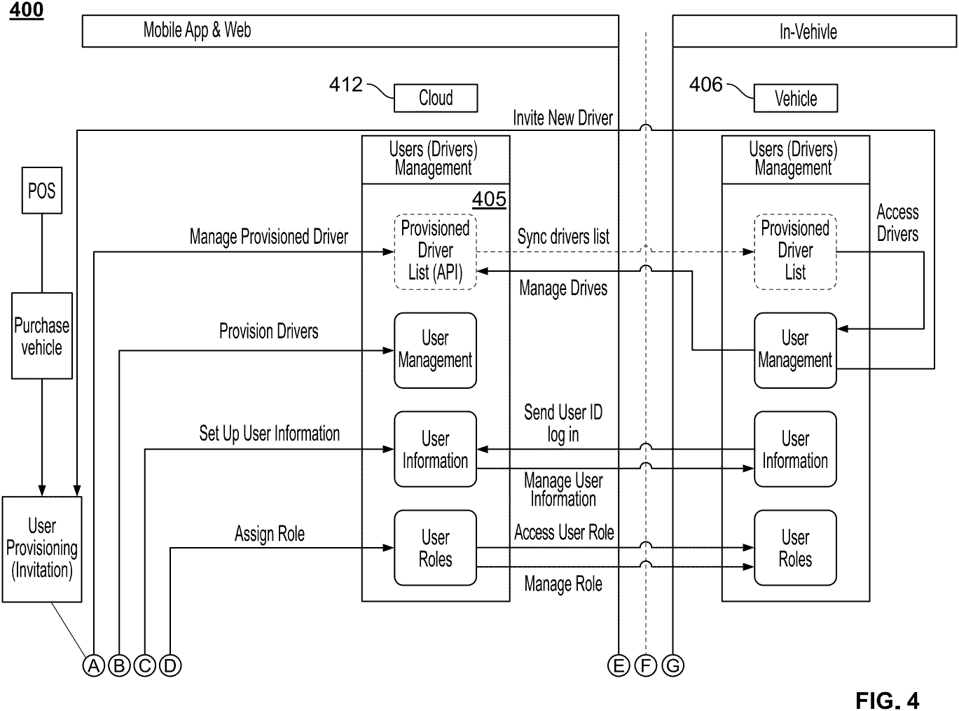

Server 212 may comprise a plurality of servers configured to remotely provide cloud computing resources (e.g., storage, processing, software applications, etc.) to other components of system 200, e.g., user device 202, user device 204 and/or vehicle 206. Server 212 may comprise processing circuitry 274, processor 276, memory 278, communications circuitry 280, and wireless network transceiver 282. Processing circuitry 276 may be configured to execute instructions (e.g., stored at memory 278) to implement any suitable portions of the functionalities described above and below. In some embodiments, server 212 may be associated with a manufacturer of vehicle 206, and may be configured to store (e.g., a cloud-based storage system such as in memory 278, e.g., a data store or a database in one or more servers 212 or otherwise maintained by or associated with server 212) information related to each vehicle sold by the manufacturer and related to an owner of each vehicle, e.g., login credentials associated with a user account and/or user profile of the vehicle owner with the manufacturer, which may be generated for and provided to the user upon his or her purchase of vehicle 206; user permissions and roles or certain user accounts or user profiles; user preferences in connection with certain user accounts or profiles, etc. Such information may be stored in any suitable format such as, for example, a database, a lookup table, a set of flags, one or more ASCII characters or words (e.g., in a text file), any other format, or any combination thereof. Server 212 may maintain or otherwise be associated with one or more data stores or databases to store user account information and user profile information (e.g., as discussed in FIGS. 3-4), such as including one or more preferred vehicle attribute settings for respective user profiles and/or user accounts. In some embodiments, server 212 may comprise a collection of servers, and processing circuitry of server 212 can be distributed across a number of servers.

FIG. 3 shows a block diagram of a system 300 for defining identity management, in accordance with some embodiments of the present disclosure. System 300 may be implemented using any suitable combination of the elements and components discussed in connection with FIGS. 1 and 2. System 300 comprises user identify portion 302 and vehicle identity domain 304. User identify portion 302 comprises user management portion 305 (e.g., providing for management of drivers or operators or passengers of vehicle 106). For example, user management portion 305 may correspond to a user account with a vehicle manufacturer or distributor, and the user account may comprise specific information, data, or credentials pertaining to a given user (e.g., User ID, avatar, e.g., including a personalized photo, first name of user, last name of user, role (e.g., primary owner, co-owner, driver) of user, view all drivers, e.g., having been granted access to a vehicle, phone, email, invite drivers option, delete drivers option, set/change roles option, owner permissioned, third-party service login, payment processing). Key management portion 308 may comprise a collection of vehicle keys (e.g., user device 102, 104, such as for example, smartphones, key fobs, key cards, wristbands, etc.) provisioned to a user (e.g., associated with a particular user ID). In some embodiments, key management portion 308 may enable a user to view user devices (e.g., keys) having been granted access to a vehicle, pair new keys, acknowledge new keys, delete keys, reassign keys, owner permissions functions, deactivate and reactivate key functions (e.g., user-based or globally), shared digital key. In some embodiments, a primary user (e.g., an owner of vehicle 106) may be provided with the ability to add provisioned user accounts to their vehicle(s), and revoke user account or profiles from their vehicle(s), and/or re-assign keys seamlessly to provisioned user accounts.

Vehicle identity domain 304 (e.g., vehicle-based) may comprise user profile management portion 310 and vehicle profile management portion 312. User profile management portion 310 may comprise a collection of user-specific settings and/or preferred vehicle attribute settings in vehicle 106 and their given states, e.g., User ID, profile alias, profile settings, profile data, guest profile management, cloud-based profile restore, multiple profiles per user account, cloud-based multiple vehicle sync). In some embodiments, a user profile may not comprise specific user information, e.g., a user profile can be associated with any user. Vehicle profile management portion 312 may comprise a collection of vehicle-specific settings and/or preferred vehicle attribute settings in, and information about, the vehicle (i.e. vehicle name, VIN, mileage odometer, charging schedule, charging settings, vehicle name, alarm settings, cabin preconditioning schedule, saved Wi-fi networks, OTA update schedule, etc.). That is, such vehicle-specific settings may be associated with a particular identifier (e.g., a VIN), which users may be provisioned to, e.g., the vehicle-specific settings may not be specific to a user.

In some embodiments, user profiles may be linked or associated with user accounts (e.g., associated with a vehicle manufacturer or distributor), and user profiles may not be associated with a particular user device 102, 104. Alternatively, in some embodiments, user profiles may be linked to user accounts. In some embodiments, user devices 102, 104 may be linked to the user account, where user credentials (e.g., a user ID and password) associated with the user account may be used to access a user profile via a user device. Such user credentials may be generated and stored at server 112 and enable log-in for a particular user (e.g., by comparing received credentials to stored credentials associated with the user account). In some embodiments, any suitable number of user devices may be linked or associated with a vehicle, and any suitable number of vehicles may be linked or associated with a user device, e.g., a smartphone may simultaneously maintain connections with different vehicles. In some embodiments, it may be desirable to limit certain user devices (e.g., a key fob or NFC device) to only be associated with a single vehicle.

FIG. 4 shows a block diagram of a system 400 for causing a user profile to be loaded at a vehicle, in accordance with some embodiments of the present disclosure. System 400, in response to determining that a vehicle has been acquired (e.g., purchased or leased), invites the new user associated with the newly acquired vehicle 406 to begin a user provisioning process. For example, the new user (e.g., accessing, on his or her mobile device, a mobile application provided by the vehicle manufacturer via cloud computing resources (“cloud”) 412, which may correspond to or otherwise implement server 212) may select one or more prompts to create a user account associated with a user ID. In some embodiments, the user ID of the user account may correspond to a unique identifier comprising a string of alphanumeric characters, and a user name of the user account may correspond to a unique identifier comprising a name of the user. In some embodiments, the user account may comprise any suitable user information input by the user or otherwise received by the mobile application from cloud 412 or vehicle 406 (e.g., via an API), such as, for example: the user’s first, last (surname), middle, nickname, honorific; the user’s addresses, e.g., home, business, shipping, billing (which may include a tag indicative of a billing method associated with the billing address); one or more of the user’s email addresses; one or more of the user’s phone numbers; home, business, mobile, other; user’s primary subscriptions (email subscription lists) for management by the user; user’s language preference; user’s notification preference; company and description fields for each user; user’s credential; user’s role mappings for cloud-based roles; user’s vehicle/role mappings, user’s property bags: platform preferences (e.g., seat position preference in the vehicle) new entity object that maps a set of vehicles and users to a fleet entity (business of organization).

After the user ID account creation, the mobile application (or web application running on a client device of the user) may be used to communicate with user management portion 405 of cloud 412 (e.g., to manage provisioned drivers; provision drivers to enable such drivers to access vehicle 406; set up user information; assign user roles, or perform any other suitable function, or any combination thereof). In some embodiments, once the user ID account creation is complete, the mobile application may be used to communicate with keys management portion 408 of cloud 412 (e.g., to manage provisioned user devices and enroll user devices in connection with vehicle 406, or perform any other suitable function, or any combination thereof) and communicate with user profile management portion 410 of cloud 412 (e.g., to set up user preferences, or perform any other suitable function, or any combination thereof). Based on such communication, cloud 412 may be configured to communicate with vehicle 406 to provide information enabling synchronization of a list of provisioned users (e.g., via an API) between cloud 412 and vehicle 406; information enabling the management of user information of the created user account at vehicle 406; information enabling vehicle 406 to access and manage user roles; information enabling synchronization of a provisioned user device list (e.g., via an API) between cloud 412 and vehicle 406; information enabling the management of user devices (e.g., key fobs or smartphones) and user preferences associated with the created user account at vehicle 406; information enabling the management of vehicle preferences (e.g., via vehicle profile management portion 413) of the created user account at vehicle 406; and/or to communicate any other suitable information.

In some embodiments, vehicle 406 may be configured to, based on information received from cloud 412, manage users (e.g., permissioned drivers or occupants of vehicle 406) and receive log-in credentials from a user and forward such credentials to cloud 412, where cloud 412 may authenticate the user. In some embodiments, the receiving of log-in credentials from the user may comprise detecting the user is approaching vehicle 406 (e.g., based on wireless signals advertised by a user device entering a predefined range of vehicle 406, or based on a user interacting with one or more buttons of a key fob or mobile device within a predefined range of vehicle 406). In some embodiments, in response to detecting that the user pressed a button or otherwise interacted with a user device (e.g., smartphone or key fob), a sensor (e.g., a BLE sensor on a key fob) may translate, or communicate with vehicle 406 and/or cloud 412 to translate, such user interaction into a user ID associated with the user account of the user. In some embodiments, vehicle 406 may be configured to, based on information received from cloud 412, manage provisioned user devices, access user preferences (e.g., associated with a particular user profile, in order to provide to the user certain preferred vehicle settings), vehicle information and vehicle settings, and/or perform any other suitable function.

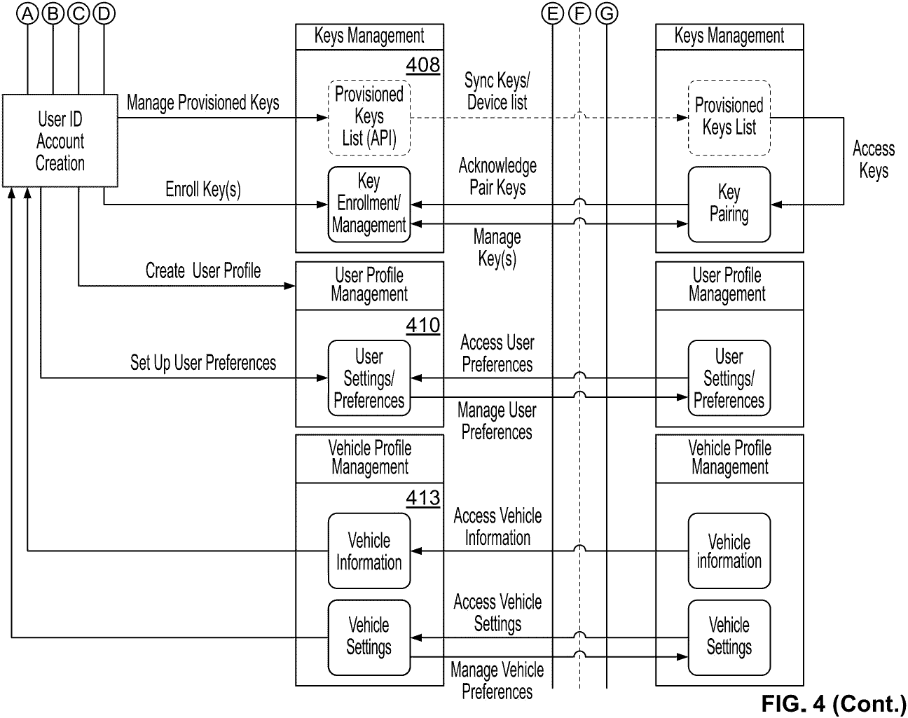

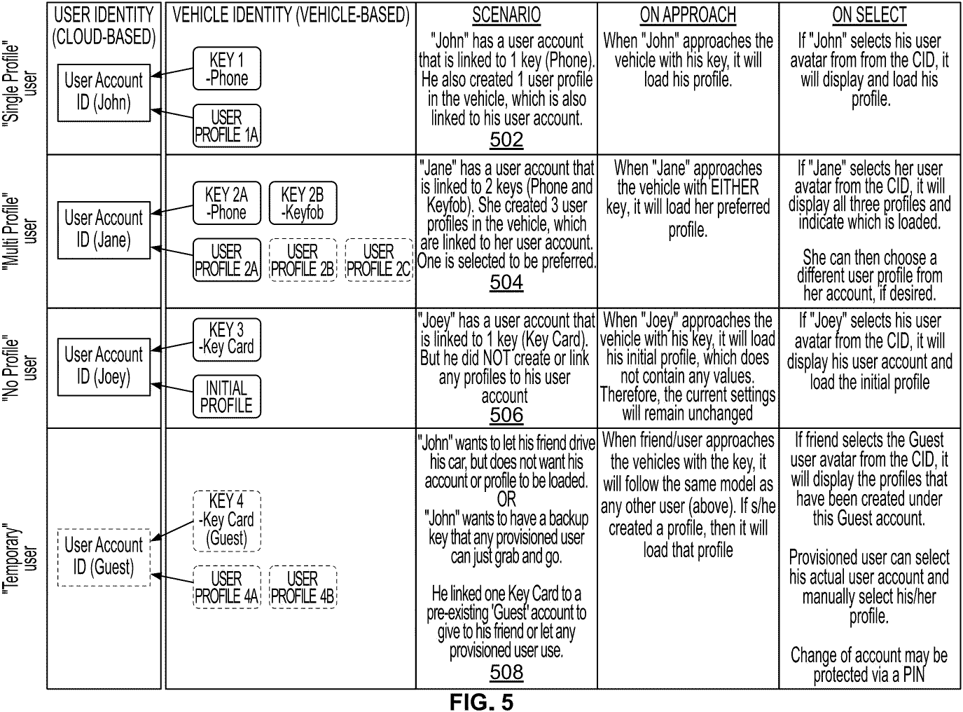

FIG. 5 shows a plurality of illustrative scenarios in which system 400 may be utilized to cause a user profile to be loaded at a vehicle, in accordance with some embodiments of this disclosure. In scenario 502, a user (e.g., John) is associated with a user account that is linked or associated with user device 102. Cloud 412 may store a user profile associated with the user account, e.g., based on instructions received from a mobile application (which may be associated with a manufacturer of vehicle 406). For example, John may have logged into the mobile application using credentials associated with the created user account to create the profile via the mobile application. Vehicle 406 may automatically log-in the user account associated with John, e.g., once vehicle 406 determines John is approaching vehicle 406, based on credentials stored at cloud 412 and/or vehicle 406, and/or based on credentials input by the user at vehicle 406 or the user device, or based on receiving other user input (e.g., pressing a button on a key fob). In response to logging into the user account, vehicle 406 and/or cloud 412 may retrieve the user profile associated with John’s user account, and cause such profile to be loaded at vehicle 406. In some embodiments, since, in scenario 502, John’s user account is associated with only one profile, such profile may be automatically loaded. In some embodiments, the user profile may be retrieved locally by vehicle 406, e.g., if vehicle 406 is in a remote location and not able to establish a connection to cloud 412 over the network (e.g., network 210). Vehicle 406 may locally store information associated with one or more user accounts or user profiles, e.g., based on receiving periodic or requested updates from cloud 412. In some embodiments, one or more user devices may be configured to locally store information related to one or more user accounts or user profiles (e.g., in connection with a mobile application).

In some embodiments, such user profile may be loaded in response to receiving user selection of an identifier of the profile, e.g., generated for presentation at display 232 of vehicle 206 and/or display 269 of user device 204. The loading of the user profile of John at vehicle 406 may enable John to experience a personalized experience in vehicle 406 in a variety of ways. For example, the user profile associated with John’s account may indicate preferred vehicle attribute settings (used to modify existing attributes of vehicle 406), e.g., a preferred type of audio (e.g., news during a morning commute, rock music during an evening commute, and/or any other suitable audio for certain times) based on a particular time of day or day of the week (or a particular time of the year), and/or may indicate certain desired settings (e.g., seat position, mirror position and/or any other suitable setting) associated with John’s profile. The profile may be built based on one or more of explicit inputs from John (e.g., selecting which music to play at certain times) or implicitly (e.g., by monitoring John’s behavior over time in various vehicle sessions to learn John’s preferences).

In scenario 504, a user (e.g., Jane) is associated with a user account that is linked or associated with multiple user devices (e.g., user devices 102 and 104). Cloud 412 may store multiple user profiles associated with the user account, e.g., based on instructions received from a mobile application associated with a manufacturer of vehicle 406, where Jane may have logged in using credentials associated with the created user account to create such profiles via the mobile application. Cloud 412 and/or vehicle 406 may store an indication in connection with Jane’s user account that one of such multiple profiles is a preferred profile of Jane. Vehicle 406 may log-in the user account associated with Jane, e.g., once vehicle 406 determines Jane is approaching vehicle 406, based on credentials stored at cloud 412 and/or vehicle 406. In some embodiments, any of the multiple user devices, e.g., held by Jane as she approaches vehicle 406, may be detected by vehicle 406 and caused to load the preferred profile of Jane. In other words, even though different user devices may be utilized by Jane, each of such devices may be associated with the same preferred user profile and the same other profiles.

In some embodiments, the preferred profile of Jane may be automatically loaded based on instructions received from vehicle 406 and/or cloud 412, or Jane may manually select, e.g., via display 232, 246 or display 269, which profile is to be loaded. In some embodiments, the various profiles associated with Janes user account may be associated with respective moods (e.g., happy, sad, excited and/or any other suitable emotion or mood of the user), which may each include respective sets of vehicle settings (e.g., speed range, music, lighting patterns of interior lights, and/or any other suitable settings) that reflect the corresponding mood. Such profiles may be selected by the user or automatically selected (e.g., based on a mood of the user, inferred at least in part by, e.g., monitoring biometric responses of the user at a current time, based on a day of the week or time, based on the user’s favorite sports team winning a game, based on analyzed text messages or emails of the user, etc.).

In scenario 506, a user (e.g., Joey) is associated with a user account that is linked or associated with a user device (e.g., user device 102); however, in this illustrative scenario, cloud 412 has not received any indications to associate a user profile to Joey’s user account. When Joey approaches vehicle 406, e.g., while holding user device 102 having been associated with Joey’s user account with the vehicle manufacturer, cloud 412 and/or vehicle 406 may cause an initial profile to be loaded which may not contain any values, e.g., current vehicle settings may be unchanged. In some embodiments, in response to receiving a selection, e.g., via a display of vehicle 406, of an identifier (e.g., avatar) of the initial profile, an indication of the user account may be displayed, and the initial user profile may be loaded. In some embodiments, the user may be notified that his or her user profile is currently empty and may be prompted to specify certain preferences in connection with user profile or create an additional user profile.

In scenario 508, a user (e.g., John) associated with a particular user account may desire to allow a friend to drive vehicle 406, where John may be assigned a role of the owner of vehicle 406. Alternatively, John may desire to designate a particular user device (e.g., a key fob) as a backup key that any provisioned user (e.g., specified by John in a request received by cloud 412 from a device from which John is accessing his user account) can use to access vehicle 406. Cloud 412 may enable John to link a user device (e.g., a key card) to a pre-existing guest account, in order to allow his friend or any provisioned user (e.g., a child of John) to use vehicle 406. Vehicle 406 may detect that such friend or provisioned user of John is approaching, and determine whether to load a guest profile, or a profile of the approaching user if such user has previously created a user profile. In some embodiments, vehicle 406 may receive selection of a guest account identifier (e.g., via a display of vehicle 406) and display any guest profiles associated with the guest account. In some embodiments, vehicle 406 may receive selection from a provisioned user of a user account or user profile associated with the provisioned user. In some embodiments, transitioning from a guest account to the user account or profile associated with the provisioned user may require entry of a PIN or password.

The cloud-based architecture described above and below may enable a primary user (e.g., having been associated with a vehicle owner role based on the purchase of vehicle 406) to have full control over users, keys/user devices, and, e.g. cloud 412 may receive indications from the primary user to add or remove access to a vehicle by way of the cloud. For example, as discussed in connection with scenario 508, a particular user device may be provisioned for a user (e.g., a family member of the primary user), as a permanent user that does not want user account. In such instance, the user device (e.g., a guest key) may be linked with the guest account (e.g., associated with the user account of the primary user). In some embodiments, there may be only one guest account linked to the user account of the primary user, or any suitable number of guest accounts may be created and linked to the user account of the primary user. In some embodiments, the provisioned user (e.g., the family member of the primary user) may be permitted to link his or her guest account or guest profile with a new user account if desired. That is, vehicle settings or historical data associated with the guest account or guest profile may be seamlessly imported into the newly created account at the request of the user.

In some embodiments, an account or profile may be created for specific circumstances (e.g., a valet scenario or showroom environment). For example, these circumstances may be accounted for in a similar manner as a temporary user (e.g., a guest user such as a friend of the primary user of the user account). In some embodiments, a valet account or valet profile may be created, and a valet role may be established. Such valet account or profile may specify that when a driver or occupant of the vehicle is in the valet role, certain vehicle settings should be applied (e.g., locked glove compartments, prohibit the vehicle from driving beyond a certain range from the venue or beyond a certain number of miles, prohibit the vehicle from driving at a speed that exceeds a specified threshold speed, provide a reading of mileage before and after the valet service, prohibit access to connected phone content, and/or any other suitable settings may be applied). In some embodiments, a showroom account or profile may specify a showroom role customized with certain vehicle setting. For example, for vehicles displayed in a showroom of a vehicle manufacturer and/or vehicle distributer, when the showroom account or profile is loaded on a particular vehicle, such account or profile may configure the vehicle to allow the user use of certain vehicle attributes or features (e.g., headlights) and prohibit the user use of certain vehicle features (e.g., windshield wipers) at any suitable level of granularity. In some embodiments, vehicles associated with the showroom role may be prohibited from driving or traveling.

The cloud-based architecture described above and below may be utilized in any suitable number of circumstances. As another example, a particular user device or user profile may be leveraged to provide for Shared Mobility (Mobility-as-a-Service), where an administrator of a user account may utilize the system to assign various tasks to various modes of transportation services to manage and schedule a trip or commute of one or more users.

In some embodiments, system 400 may be used to manage a commercial fleet of vehicles. For example, cloud 412 may associate a particular user account with a fleet of commercial (e.g., delivery) vehicles, where such user account may be an administrative account associated with an operator of the fleet. The operator may be, e.g., one of the drivers of the vehicles of the fleet or an administrator employed by a company associated with the fleet, where such company may employ or contract the drivers. The administrative account may be used to manage fleet-level specific information, data, and role. In some embodiments, system 400 may permit drivers to create user accounts or profiles for themselves, as allowed per the permissions defined by the role. Cloud 412 may associate a plurality of user devices (e.g., key fobs, smart phones of the drivers of the fleet) with the user account, and each of such user devices may be associated with client account or profile associated with a respective client user (e.g., a driver or employee of the company associated with the administrative account). The administrative account may be used to associate respective vehicles from the fleet of vehicles to respective client accounts or profiles. For example, system 400 may enable a particular driver (e.g., Ted) to be assigned to a particular commercial vehicle on a particular day, whereas another driver (e.g., Melissa) may be assigned to another commercial vehicle on that day, by provisioning user devices and/or user accounts or user profiles associated with the particular driver to access their particular vehicles. In some embodiments, the administrator account may be dynamically configured to respond to current needs, e.g., to provision drivers for individual vehicles on the fly, to optimize vehicle usage and logistical efficiency of assigning particular vehicles of the fleet to particular drivers, and/or to address any other suitable scenario that may arise. In some embodiments, the systems and applications provided herein may, in managing the commercial fleet of vehicles, perform hierarchical granting of rights with respect to user profiles or user accounts associated with the fleet. For example, additionally or alternatively to the above-described features, the system may take into account that certain users (e.g., a senior delivery person) may be granted more permissions and/or provided with a superior vehicle, relative to other users (e.g., an inexperienced delivery person).

In some embodiments, system 400 enables a driver of the fleet of vehicles assigned to the particular vehicle to access his or her user account or profile within the assigned vehicle to personalize his or her driving experience. For example, when the driver approaches his or her assigned vehicle, e.g., with his provisioned user device, he or she may be logged into an account (e.g., a guest account) or profile, and a desired profile may be loaded at the vehicle to enable certain vehicle attributes or features such as audio preferences, ergonomic preferences within the vehicle and/or historical navigation data associated with the user profile to be leveraged to improve the experience of the user. In some embodiments, personal data of the user associated with the user profile and utilized during the vehicle session may not be stored at the vehicle, to avoid privacy concerns of sharing the vehicles of the fleet between drivers. In some embodiments, only one user, or more than one user, may be given administrative rights.

In some embodiments, system 400 may enable user to share accounts or profiles, and/or certain preferences or settings indicated in the accounts or profiles, with another user. For example, a user associated with a first user profile may have a preferred setting (e.g., an audio playlist) and share such playlist with another user associated with another profile, another user account and/or another vehicle. In some embodiments, different user profiles associated with a particular user account may have different log-ins for various services (e.g., Alexa voice assistant, Spotify music service), enabling each user to access his or her personal accounts when accessing the vehicle.

In some embodiments, system 400 may enable users (e.g., a husband and a wife) having different user accounts and different vehicles, to grant each other access to each other’s vehicles. For example, a first user (e.g., a husband) may have a user account and/or user profile with a first set of preferences (e.g., music, ergonomics, etc.) and may be the owner of a first vehicle, while a second user (e.g., a wife) may have a user account and/or user profile with a second set of preferences (e.g., music, ergonomics, etc.) and may be the owner of a second vehicle. System 400 including cloud 412 may enable the first user to grant the second user access to the first vehicle, and enable the second user to utilize her user account or profile while accessing the first vehicle. Similarly, system 400 including cloud 412 may enable the second user to grant the first user access to the second vehicle, and enable the first user to utilize his user account or profile while accessing the second vehicle. In some embodiments, if the first user or the second user has not created a user account, he or she may be provisioned with a user device (e.g., a key card) to enable access to a vehicle. In the above described example, the user ID associated with the user account of the first user may be linked or associated with the user ID associated with the user account of the second user, and vice versa. In some embodiments, access limitations may be imposed by, e.g., a primary user on a secondary user (e.g., the first user may set a maximum speed at which the first vehicle may reach when the second user occupies the first vehicle). In some embodiments, for certain provisioned user devices, the primary user may specify (e.g., via UI screens of FIGS. 8A-8I) the scope of permitted behavior or permitted accessible features (e.g., a child of the primary user may not be permitted access to autonomous driving when occupying the vehicle in connection with his or her user account or user profile).

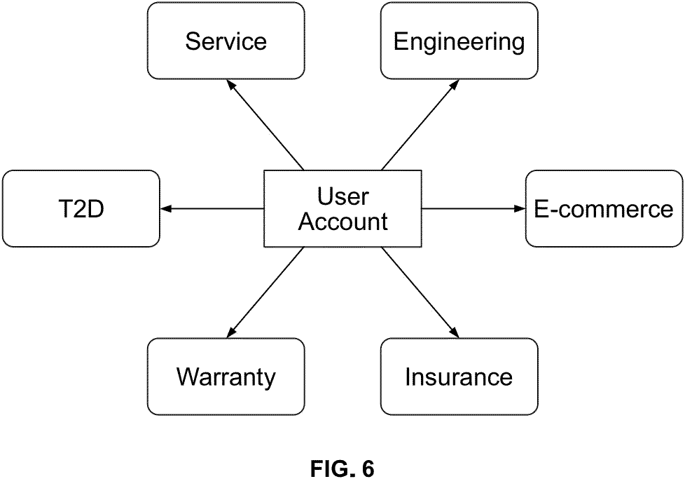

FIG. 6 shows a block diagram illustrating various areas in which the user account may be utilized, in accordance with some embodiments of this disclosure. For example, the cloud-based architecture of the system described above and below may enable various entities (e.g., an Insurance company) to have visibility into use of a vehicle insured by the company, and vice versa.

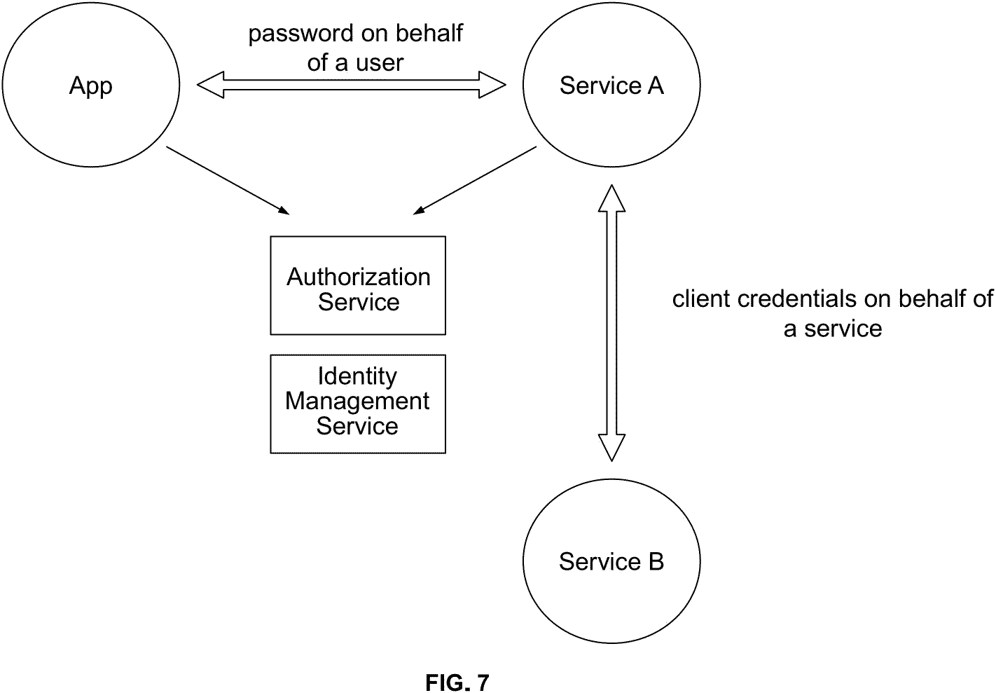

FIG. 7 shows an illustrative authorization service, in accordance with some embodiments of this disclosure. The cloud-based architecture utilizing user accounts, as described above and below, may utilize an authorization service that provides applications and services a means to operate as authorized entities. In some embodiments, either the application or service can request an access token from the authorization service, and to operate as a user, the requestor may use a suitable function, e.g., a ‘password’ grant type. The resulting access token may represent that user, e.g., all roles assigned to that user may be conferred to the target service (the target service can elect to process the request or not depending on the rights available within the user’s roles). In some embodiments, for service to service authorization, the requesting service may use a function, e.g., a ‘client_credentials’ grant_type, and the resulting access token may represent that service, e.g., all roles assigned to that service (“Service A”) may be conferred to the target service (“Service B”), and the target service can elect to process the request or not depending on the rights available within the client service’s roles.

In some embodiments, the cloud-based architecture utilizing user accounts, as described above and below, may be an RBAC (role-based access control) system, where the user or the service may be assigned roles that define its access to the target service. In some embodiments, these roles may be a collection of rights (understood by the target service), e.g., the target service (“Service B”) may have the following roles: service-b-admin, service-b-manager, and service-b-user, and each of these roles may contain rights understood by the service B. When such service receives an API request, the service can verify the access token and receive a list of rights from all associated roles, and the service then can check the specific right based on the request and either accept or deny the request. In some embodiments, grant types may utilize a client ID and a client secret, and one or more of the client ID and the client secret may be used to retrieve information of a user. In some embodiments, third party systems that access user information may receive a private user identifier, which maps back to a specific user but prevents the third party system from cross-referencing IDs.

FIGS. 8A-8I shows illustrative user interface (UI) screens which may be provided, in accordance with some embodiments of this disclosure. Such UI screens may be provided at, e.g., display 246 of user device 202, display 269 of user device 204, and/or display 232 of vehicle 206. In some embodiments, the UI screens of FIGS. 8A-8I may be provided by a mobile application (e.g., running at least in part on a smart phone or other user device 102, 104 and in communication with server 112 hosting the application).

FIG. 8A shows UI screen 801 of a smartphone depicting a logged in user account corresponding to a user indicated at 806 having the user name of “Palo Alto Lab.” UI screen 801 indicates the user associated with user account 802 owns and/or has been granted access (e.g., pending digital key setup) to six vehicles.

FIG. 8B shows UI screen 803 which enables a user to add his or her user device (e.g., smart phone) as a user device or key for his or her vehicle 106 of which the user is the designated owner. In some embodiments, such setup occurs in vehicle 106 itself. UI screen 803 may permit the user to manage his or her drivers and keys associated with his or her vehicle 106, e.g., by revoking access to a particular driver or key, such as if the user no longer wishes a particular driver to have access to his or her vehicle, or if a particular key has become lost. In some embodiments, UI screen 803 may permit the user to view vehicle information associated with his or her vehicle 106 and stored at server 112 and/or vehicle 106 and/or user device 102, 104.

FIG. 8C shows UI screen 805 which provides a list of drivers, e.g., having been granted access to vehicles associated with the user account. UI screen 805 indicates that the user account is associated with 9 user devices or keys provisioned to access vehicle 106. UI screen 805 may enable the user indicated at 806 to share one of such keys with another user and/or invite a driver to access vehicle 106 or any other vehicle associated with the user account of the user indicated at 806.

FIG. 8D shows UI screen 807 which provides a list of keys or user devices drivers, e.g., smart phones, key fobs, wireless cards, associated with the user indicated at 806. UI screen 805 may enable the user indicated at 806 to share one of such keys with another user and/or invite a driver to access vehicle 106 or any other vehicle associated with the user account of the user indicated at 806.

FIG. 8E shows UI screen 809 which provides various information associated with the user indicated at 806, e.g., a user name, email, role (e.g., owner), avatar, key information, etc. FIG. 8F shows UI screen 809 which provides various information associated with user 808, e.g., a user name “Vincent Jones”, email, role (e.g., DRIVER), avatar, key information (e.g., no active keys), etc. Selectable option 810 may enable the user indicated at 806 to revoke the access of user 808 to vehicles associated with the user account of the user indicated at 806, e.g., to delete a provisioned user’s account or profile and remove such provisioned user’s access to the vehicle. In some embodiments, the avatar may be customizable by the user via the UI screen. FIG. 8G shows UI screen 813 which includes prompt 816 for the user indicated at 806 to confirm the revocation of access for user 814. FIG. 8H shows UI screen 815 which enables the user indicated at 806 to invite drivers to user their phones as a key to access vehicle 106 of the user indicated at 806, e.g., by selecting a user to invite from the smartphone contacts of the user indicated at 806 or emailing such user. FIG. 8I shows UI screen 817 enabling a user to delete a user device, e.g., a phone key having been granted access to a vehicle associated with user account 802. In some embodiments, if the vehicle is in use while the user device is deleted, the access may persist until server 112 receives an indication that vehicle 106 is in park, at which point the revoked user device may not be usable to drive the vehicle.

In some embodiments, a user device (e.g., key fob 104) may, during manufacturing, be programmed to only match the vehicle corresponding to the user device (e.g., based on vehicle information stored at server 112). Once the user receives the user device, he or she may log in to, e.g., the mobile application, in order to activate the user device. Such features may be useful in that if the user device is intercepted prior to user receipt, the user device may be configured not to be usable by the interceptor, e.g., the logging in step may be required to activate the user device.

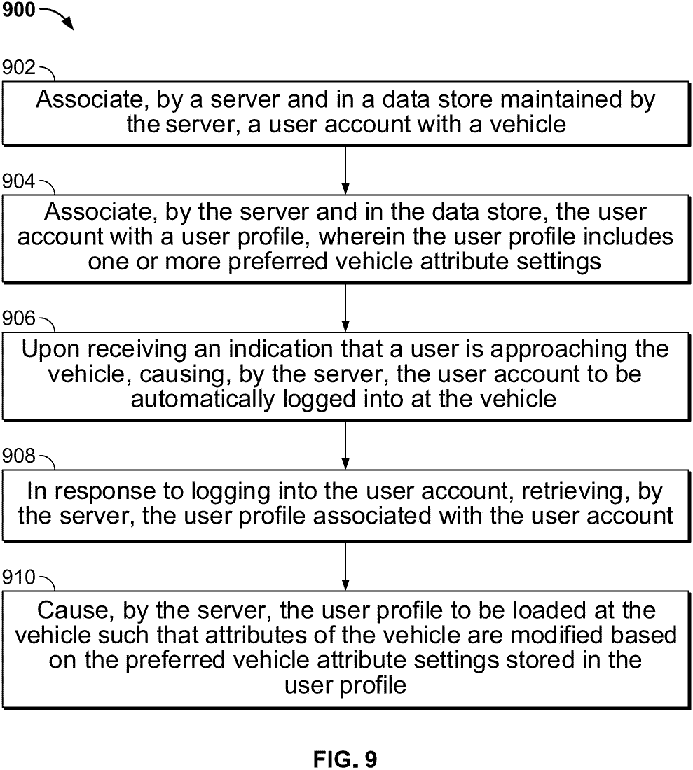

FIG. 9 shows a flowchart of illustrative process 900 for causing a user profile to be loaded at a vehicle, in accordance with some embodiments of the present disclosure. Process 900 may be executed at least in part by processing circuitry 216, and processing circuitry 240 and/or processing circuitry 262, and/or processing circuitry 274.

At 902, processing circuitry 274 of server 212 may be configured to associate, in a data store maintained by the server (e.g., memory 278 or another database), a user account indicated at 802 with vehicle 106. For example, a user may purchase or otherwise acquire vehicle 106, and a user invitation may be transmitted over network 210 to the user (e.g., to an email address or mobile device of the user) by cloud 412 or vehicle 406, which may prompt the user to create his or her user account, and a user account ID may be associated with the generated user account at server 212 and vehicle 106 purchased by the user.

At 904, processing circuitry 274 of server 212 may associate, at the data store, the user account with a particular user profile. For example, user profile management portion 410 of cloud 412 may enable a user to create a user profile associated with a particular time of day (e.g., morning commute), time of the week (e.g., weekend excursion) or mood (e.g., happy, sad, excited). The user profile may comprise one or more preferred vehicle attribute settings, used to modify vehicle attribute settings of vehicle 206, e.g., during a future driving session.

At 906, server 212 and/or vehicle 206 may log into the user account indicated at 802 at vehicle 906. In some embodiments, such log-in may occur automatically in response to determining that a user device 102 associated with the user account has entered a predefined range of vehicle 906, that user interaction has occurred with respect to user device 102, or that login credentials associated with the user account may be manually supplied by a user (e.g., at user device 102 or vehicle 106) to server 212.

At 908, processing circuitry 274 of server 212 may retrieve the user profile associated with the user account. For example, the retrieved user profile may correspond to a preferred user profile of the user, a user profile corresponding to the determined time of day or time of the week, a profile selected via a user interface of the vehicle or the user device, etc.

At 910, processing circuitry 274 and/or communications circuitry 280 of server 212 (and/or processing circuitry 216 of vehicle 206) may cause the selected user profile to be loaded at vehicle 106 such that attributes of the vehicle are modified based on the preferred vehicle attribute settings stored in the user profile. For example, the user profile may be loaded and processing circuitry 216 of vehicle 206 may be configured to personalize the driving experience of the user (e.g., now occupying vehicle 206) based on the user profile, e.g., based on any suitable preference specified in the user profile such as, for example, seat positions, mirror positions, audio preferences, etc. Thus, default settings of the vehicle, or settings associated with a different user profile, may be replaced with the preferred vehicle attribute settings stored in the user profile for the current vehicle session.

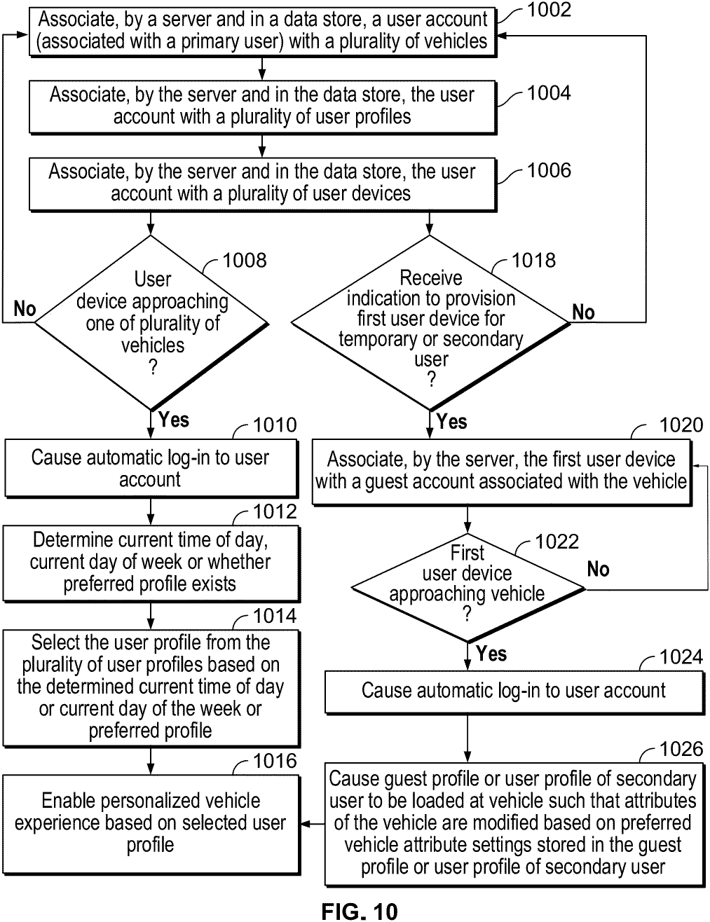

FIG. 10 shows a flowchart of illustrative process 1000 for causing a user profile to be loaded at a vehicle, in accordance with some embodiments of the present disclosure. Process 1000 may be executed at least in part by processing circuitry 216, and processing circuitry 240 and/or processing circuitry 262, and/or processing circuitry 274.

1002 may be performed in a similar manner as to 902 of FIG. 9. In some embodiments, the user account indicated at 802 may be associated with a primary user (e.g., “Palo Alto Lab” indicated at 806) which may be designated at cloud 412 in an owner role in connection with one or more vehicles. 1004 and 1006 may be performed in a similar manner as discussed in connection with 904 and 906, respectively. In some embodiments, multiple user profiles may be associated with the user account at 1004 (e.g., for various times of day, for various users, for various times of the week), and multiple user devices (e.g., a key fob, an example of user device 104, a smart phone, an example of user device 102) may be associated with the user account at 1006.

At 1008, one or more of user device 102 or 104, vehicle 106 and server 112 may determine whether a user device that is associated with the user account is approaching one of the plurality of vehicles. For example, server 112 may receive an indication from vehicle 106 over network 110 that user device 102 (e.g., associated with user account 802) has entered a predefined range of vehicle 106 and/or was interacted with in a vicinity of vehicle 106 (e.g., an unlock button was pressed).

1010 may be performed in a similar manner as 906. At 1112, one or more of user device 102 or 104, vehicle 106 and server 112 may determine a current time of day, current day of week or whether a preferred profile exists in association with the user account. At 1114, a suitable profile may be selected for loading at vehicle 106 to enable a personalized vehicle experience for the primary user at 1116. For example, at if the current time is 1:00 PM on a Sunday during football season, and the user profile specifies one or more preferred vehicle attribute settings, e.g., indicating an interest in football and/or a particular team, a profile associated with football may be selected (e.g., providing a broadcast of a football game in which the user’s favorite team is competing to the user during the driving session). As another example, in response to determining that a current time corresponds to a weekend excursion trip with family members of the primary user, certain vehicle features may be activated (e.g., all-wheel drive, family friendly audio soundtrack, etc.).

At 1018, sever 212 may receive an indication (e.g., via a mobile application) to provision a first user device for temporary or secondary user. For example, the indication may correspond to a valet mode, or to a more permanent arrangement of granting the primary user’s family member access to the vehicle. In response to receiving this indication, processing may proceed to 1020.

At 1020, server 212 may associate first user device 104 with a guest account associated with the vehicle. In some embodiments, the guest account may comprise one or more guest profiles. The primary user may physically transfer first user device 104 to the temporary or secondary user, or provision right of access to such user by transmitting an instruction to cloud 412.

1022 may be performed in a similar manner as to 1008, with respect to first user device 104, and at 1024, server 212 may authenticate the guest user account having been associated with first user device 104. In some embodiments, the user (e.g., the family member of the primary user) may already have a user account or user profile, and may be permitted to access such user account or user profile rather than the guest account. At 1026, the guest profile or secondary user’s profile may be loaded at vehicle 106, and the personalized driving experience of 1016 (e.g., tailored to the user and/or limiting features to the user, such as, for example, a valet mode or a showroom mode) may be provided to such user. In some embodiments, loading of the user profile causes the attributes of the vehicle (e.g., default attributes, or attributes associated with a user profile of a prior vehicle session) to be modified based on the preferred vehicle attribute settings stored in the guest user profile or the user profile of the secondary user, as appropriate.

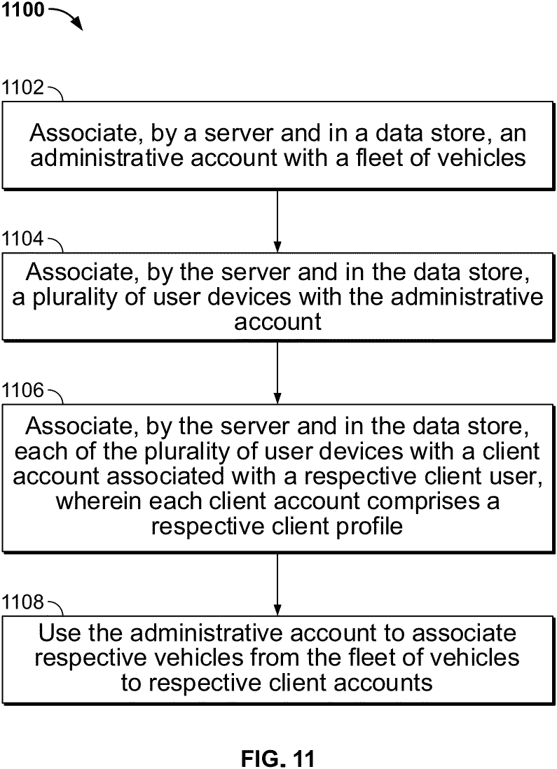

FIG. 11 shows a flowchart of illustrative process 1100 for causing a user profile to be loaded at a vehicle, in accordance with some embodiments of the present disclosure. Process 1100 may be executed at least in part by processing circuitry 216, and processing circuitry 240 and/or processing circuitry 262, and/or processing circuitry 274.

At 1102, server 112 may associate an administrative account with a fleet of vehicles. In some embodiments, the administrative account may be administered by an entity (e.g., an e-commerce company) with a fleet of delivery vehicles driven by employees or agents of the company.

At 1104, server 112 may associate a plurality of user devices with the administrative account. For example, server 112 may associate user devices (e.g., smartphones) of the various employees of agents that may be hired to drive the delivery vehicles, and/or user devices (e.g., key fobs or wireless access cards) may be physically distributed to such employees.

At 1106, server 112 may associate each of the plurality of user devices (e.g., 102, 104) with a client account associated with a respective client user, e.g., each employee or agent hired to drive a vehicle of the fleet of vehicles. For example, each driver may receive an email invitation, e.g., via UI screen 8C, to set up an account or profile in connection with a vehicle associated with the administrative account.

At 1108, one or more of server 112 and/or a mobile application (e.g., running on a user device of an operator of the administrative account) may use the administrative account to associate respective vehicles from the fleet of vehicles to respective client accounts. For example, based on which drivers are available to drive, driving routes for a particular driver, needs of the entity associated with the fleet of vehicles, drivers may be strategically assigned to maximize efficiency of the vehicle fleet. In some embodiments, each client account or profile may be utilized in the assigned vehicle to provide a personalized driving experience to the driver. In some embodiments, the vehicle may not store personal information, or any other information associated with the driver’s client account or profile. In some embodiments, loading of the user profile for the respective driver causes the attributes of the respective vehicle of the fleet of vehicles to be modified based on the preferred vehicle attribute settings stored in the respective client profiles.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A computer-implemented method comprising:
associating, by a server and in a data store maintained by the server, a user account with a vehicle;
associating, by the server and in the data store, the user account with a user profile, wherein the user profile includes one or more preferred vehicle attribute settings;
upon receiving an indication that a user is approaching the vehicle, causing, by the server, the user account to be automatically logged into at the vehicle;
in response to logging into the user account, retrieving, by the server, the user profile associated with the user account; and
causing, by the server, the user profile to be loaded at the vehicle such that attributes of the vehicle are modified based on the preferred vehicle attribute settings stored in the user profile.

2. The method of claim 1, further comprising:
associating, by the server and in the data store, the user account with a user device, wherein the user device is a smartphone, a key fob, a key card, or a short-range wireless access device.

3. The method of claim 2, wherein receiving the indication that the user device is approaching the vehicle comprises:
receiving an indication of user interaction with the user device within a predefined vicinity of the vehicle.

4. The method of claim 1, further comprising:
associating, by the server and at the data store, the user account with a secondary vehicle;
causing, by the server, the user account to be automatically logged into the secondary vehicle;
in response to logging into the user account at the secondary vehicle, retrieving, by the server, the user profile associated with the user account; and
causing the user profile to be loaded at the secondary vehicle such that attributes of the secondary vehicle are modified based on the preferred vehicle attribute settings stored in the user profile.

5. The method of claim 1, wherein the user account is associated with a user, the method further comprising:
associating, by the server and at the data store, the user account with a plurality of user profiles, each of the user profiles being associated with the user;
determining a current time of day or a current day of the week; and
selecting the user profile from the plurality of user profiles based on the determined current time of day or current day of the week.

6. The method of claim 1, wherein the user account is associated with a user, the method further comprising:
associating, by the server and at the data store, the user account with a plurality of user profiles, each of the user profiles being associated with the user; and
determining that one of the plurality of user profiles is specified as a preferred user profile,
wherein retrieving, by the server, the user profile associated with the user account comprises retrieving the preferred user profile such that attributes of the vehicle are modified based on the preferred vehicle attribute settings stored in the preferred user profile.

7. The method of claim 1, wherein causing, by the server, the user profile to be loaded at the vehicle comprises:
causing an identifier of the user profile to be generated for display at a display of the vehicle; and
receiving selection of the identifier.

8. The method of claim 1, further comprising:
associating, by the server and at the data store, a plurality of user devices with the user account,
wherein logging into the vehicle is performed in response to determining that any of the plurality of user devices are approaching the vehicle.

9. The method of claim 1, wherein:
the server is configured to permit the one or more vehicle attribute settings to be shared with another user account associated with another vehicle.

10. The method of claim 1, further comprising:
associating, by the server and at the data store, a plurality of user devices with the user account;
receiving an indication from a primary user associated with the user account to provision a first user device of the plurality of user devices for a temporary user of the vehicle;
associating, by the server and at the data store, the first user device with a guest account associated with the vehicle;
in response to logging into the guest account, retrieving, by the server a guest profile associated with the guest account; and
causing, by the server, the guest profile to be loaded at the vehicle such that attributes of the vehicle are modified based on preferred vehicle attribute settings stored in the guest profile.

11. The method of claim 1, further comprising:
associating, by the server and at the data store, a plurality of user devices with the user account; and
receiving an indication from a primary user associated with the user account to provision a first user device of the plurality of user devices for a secondary user;
associating, by the server and at the data store, the first user device with a guest account associated with the vehicle,
logging into the guest account at the vehicle; and
in response to logging into the guest account:
retrieving, by the server, a user profile of the secondary user associated with the guest account; and
causing, by the server, the user profile of the secondary user to be loaded at the vehicle such that attributes of the vehicle are modified based on preferred vehicle attribute settings stored in the user profile of the secondary user.

12. The method of claim 1, further comprising:
associating, by the server and at the data store, a plurality of user devices with the user account; and
receiving an indication from a primary user associated with the user account to associate a first user device of the plurality of user devices with a user account associated with another user; and
associating, by the server and at the data store, the first user device with the user account of said another user.

13. A computer-implemented system comprising:
a data store; and
a server configured to:
associate, in the data store maintained by the server, a user account with a vehicle;
associate, in the data store, the user account with a user profile, wherein the user profile includes one or more preferred vehicle attribute settings;
upon receiving an indication that a user is approaching the vehicle, cause the user account to be automatically logged into at the vehicle;
in response to logging into the user account, retrieve the user profile associated with the user account; and
cause the user profile to be loaded at the vehicle such that attributes of the vehicle are modified based on the preferred vehicle attribute settings stored in the user profile.

14. The system of claim 13, wherein the server is further configured to:
associate, in the data store, the user account with a user device, wherein the user device is a smartphone, a key fob, a key card, or a short-range wireless access device.

15. The system of claim 13, wherein the server is further configured to:
associate, at the data store, the user account with a secondary vehicle;
cause the user account to be automatically logged into the secondary vehicle;
in response to logging into the user account at the secondary vehicle, retrieve the user profile associated with the user account; and
cause the user profile to be loaded at the secondary vehicle such that attributes of the secondary vehicle are modified based on the preferred vehicle attribute settings stored in the user profile.

16. The system of claim 13, wherein the user account is associated with a user, and the server is further configured to:
associate, at the data store, the user account with a plurality of user profiles, each of the user profiles being associated with the user;
determine a current time of day or a current day of the week; and
select the user profile from the plurality of user profiles based on the determined current time of day or current day of the week.

17. A computer-implemented method comprising:
associating, by a server and at a data store, an administrative account with a fleet of vehicles;
associating, by the server and at the data store, a plurality of user devices with the administrative account;
associating, by the server and at the data store, each of the plurality of user devices with a client account associated with a respective client user, wherein each client account comprises a respective client profile; and
using the administrative account to associate respective vehicles from the fleet of vehicles to respective client accounts.

18. The method of 17, further comprising:
receiving an indication from an operator associated with the administrative account to associate global vehicle settings with the fleet of vehicles.

19. The method of claim 18, further comprising:
determining that vehicle settings of a particular client profile conflict with global settings of the administrative account; and
in response to determining that the conflict exists, causing the global settings to be applied instead of the conflicting client profile settings.

20. The method of claim 17, further comprising:
providing a notification, to each respective client account, of which vehicle from the fleet of vehicles the client account was associated.
